(19) United States
(12) Patent Application Publication
(10) Pub. No.: US 2024/0225130 A9
(43) Pub. Date: Jul. 11, 2024

(54) APPARATUS FOR A NON-COMBUSTIBLE AEROSOL PROVISION DEVICE

(71) Applicant: Nicoventures Trading Limited, London (GB)

(72) Inventors: Thomas Paul BLANDINO, Madison, WI (US); Terrence MILLIGAN, Madison, WI (US)

(21) Appl. No.: 18/547,008

(22) PCT Filed: Feb. 21, 2022
(86) PCT No.: PCT/GB2022/050468

§ 371 Date: Aug. 18, 2023

Related U.S. Application Data
(60) Provisional application No. 63/200,252, filed on Feb. 24, 2021.

(30) Foreign Application Priority Data
Feb. 24, 2021 (US) 63200252

(51) Int. Cl. A24F 40/57; A24F 40/20; A24F 40/465; H02M 7/5387; H05B 6/06; H05B 6/10

(52) U.S. Cl. CPC A24F 40/57; A24F 40/20; A24F 40/465; H02M 7/5387; H05B 6/06; H05B 6/105

(57) ABSTRACT

An apparatus for a non-combustible aerosol provision device can include an induction circuit including an induction element for inductively heating a susceptor arrangement arranged to heat an aerosol-generating material to thereby generate an aerosol; drive circuitry arranged to provide, from an input direct current, a varying voltage across the induction circuit for driving the induction element to inductively heat the susceptor arrangement; and control circuitry. The control circuitry is configured to cause the drive circuitry to selectively operate: in a first mode in which the drive circuitry repeatedly alternates a polarity of the voltage provided across the induction circuit; and in a second mode in which the drive circuitry repeatedly alternates between providing a first voltage of non-zero magnitude across the induction circuit and providing substantially no voltage across the induction circuit.

### PRIORITY CLAIM

The present application is a National Phase entry of PCT Application No. PCT/GB2022/050468, filed Feb. 21, 2022, which claims priority from U.S. Application No. 63/200,252, filed Feb. 24, 2021, each of which is hereby fully incorporated herein by reference.

### TECHNICAL FIELD

The present disclosure relates to apparatus for a non-combustible aerosol provision device, and more specifically to apparatus for a non-combustible aerosol provision device comprising an induction element for inductive heating of a susceptor for heating an aerosol-generating material in use.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

According to a first aspect of the present disclosure there is provided apparatus for a non-combustible aerosol provision device, the apparatus comprising: an induction circuit comprising an induction element for inductively heating a susceptor arrangement arranged to heat an aerosol-generating material to thereby generate an aerosol; drive circuitry arranged to provide, from an input direct current, a varying voltage across the induction circuit for driving the induction element to inductively heat the susceptor arrangement; and control circuitry configured to cause the drive circuitry to selectively operate: in a first mode in which the drive circuitry repeatedly alternates a polarity of the voltage provided across the induction circuit; and in a second mode in which the drive circuitry repeatedly alternates between providing a first voltage of non-zero magnitude across the induction circuit and providing substantially no voltage across the induction circuit.

The drive circuitry may comprise a plurality of switching elements arranged in an H-bridge configuration. The plurality of switching elements may comprise a high side pair of switching elements comprising a first switching element and a second switching element and a low side pair of switching elements comprising a third switching element and a fourth switching element, wherein the first switching element and the third switching element are electrically connected to the first side of the induction circuit and the second switching element and the fourth switching element are electrically connected to the second side of the induction circuit.

The drive circuitry may be arranged for connection of an electric potential in use across a first point between the high side pair of switching elements and a second point between the low side pair of switching elements.

In the first mode, the control circuitry may cause the drive circuitry to alternate between: allowing current to flow through the first switching element and the fourth switching element to cause the voltage across the induction circuit to have a positive polarity; and allowing current to flow through the second switching element and the third switching element to cause the voltage across the induction circuit to have a negative polarity. In the second mode, the control circuitry may cause the drive circuitry to alternate between: allowing current to flow through the first switching element and the fourth switching element to cause the voltage across the induction circuit to have a positive polarity, or allowing current to flow through the second switching element and the third switching element to cause the voltage across the induction circuit to have a negative polarity; and providing substantially no voltage across the induction circuit.

The control circuitry may be configured to cause the drive circuitry to operate in the first mode or the second mode by providing one or more drive signals configured to control which of the switching elements, at any one time, allows current to flow therethrough.

The control circuitry may be configured to supply a first drive signal to control switching of the first switching element and the third switching element. The control circuitry may be configured to supply a second drive signal to control switching of the second switching element and the fourth switching element.

In the first mode, a value of the first drive signal may alternate at a first drive frequency and the second drive signal may be inverted with respect to the first drive signal to cause the polarity of the voltage across the induction circuit to alternate at the first drive frequency. In the second mode, the value of the first drive signal may alternate at a second drive frequency and the second drive signal may be configured to cause the second switching element to be maintained in a state in which current is substantially prevented from flowing through the second switching element and the fourth switching element to be maintained in a state in which current is allowed to flow through the fourth switching element.

The control circuitry may be configured to determine the second drive signal based at least in part on the first drive signal.

The control circuitry may be configured to determine the second drive signal based on, in addition to the first drive signal, a control signal.

The control circuitry may comprise a controller configured to output the first drive signal and the control signal.

The control signal may be configured to determine in which of the first mode and the second mode the driver arrangement is caused to operate.

The control circuitry may comprise a signal processing element configured to receive as inputs the first drive signal and the control signal and to output the second drive signal.

The signal processing element may be a NOR gate.

The control circuitry may be configured to control the degree to which the induction element heats the susceptor arrangement by controlling a switching frequency of the switching elements to control a frequency of the varying current supplied to the induction element.

The switching elements may be transistors and the control circuitry may be configured to control respective switching potentials supplied to each of the transistors to control switching of the transistors.

Each of the transistors may be an n-channel field effect transistor. Each of the transistors may, for example, be an n-channel metal-oxide-semiconductor field effect transistor.

Each of the transistors may comprise a source, a drain, and a gate, wherein in use the respective switching potentials are provided to the gate of each transistor.

The induction circuit may be an LC resonant circuit comprising the induction element.

The LC resonant circuit may comprise the induction element arranged in series with a capacitive element.

The control circuitry may be configured to control the degree to which the induction element heats the susceptor arrangement by controlling in which of the first mode and the second mode the drive circuitry is operating.

According to a second aspect of the present disclosure there is provided a non-combustible aerosol provision device comprising: the apparatus according to the first aspect of the present disclosure.

The non-combustible aerosol provision device may comprise: a DC power source, the DC power source being arranged to provide the input direct current in use and/or the or a switching potential in use.

The non-combustible aerosol provision device may comprise the susceptor arrangement arranged to be inductively heated by the induction element in use.

According to a third aspect of the present disclosure there is provided a non-combustible aerosol provision system comprising: the non-combustible aerosol provision device according to the second aspect of the present disclosure; and the aerosol-generating material; wherein, in use, the aerosol-generating material is arranged to be heated by the susceptor to generate the aerosol.

The aerosol-generating material may be or comprise tobacco.

According to a fourth aspect of the present disclosure there is provided a method of controlling apparatus for a non-combustible aerosol provision device, the apparatus comprising: an induction circuit comprising an induction element for inductively heating a susceptor arrangement arranged to heat an aerosol-generating material to thereby generate an aerosol; drive circuitry arranged to provide, from an input direct current, a varying voltage across the induction circuit for driving the induction element to inductively heat the susceptor arrangement; and control circuitry; wherein the method comprises: causing, by the control circuitry, the drive circuitry to selectively operate in a first mode in which the drive circuitry repeatedly alternates a polarity of the voltage provided across the induction circuit, and a second mode in which the drive circuitry repeatedly alternates between providing a first voltage of non-zero magnitude across the induction circuit and providing substantially no voltage across the induction circuit.

Further features and advantages of the disclosure will become apparent from the following description of various embodiments of the disclosure, given by way of example only, which is made with reference to the accompanying drawings.

### BRIEF DESCRIPTION OF THE DRAWINGS

FIG. 1 illustrates schematically a non-combustible aerosol provision device, according to an example.

FIG. 2 illustrates schematically apparatus for use with an induction element for a non-combustible aerosol provision device, according to an example.

FIG. 3 illustrates a portion of apparatus for use with an induction element for a non-combustible aerosol provision device, according to an example.

FIG. 4 illustrates another portion of apparatus for use with an induction element for a non-combustible aerosol provision device, according to an example.

### DETAILED DESCRIPTION OF THE DRAWINGS

Induction heating is a process of heating an electrically conducting object, which may be referred to as a susceptor, by electromagnetic induction. An induction heater may comprise an induction element, such as an electromagnet, and circuitry for passing a varying electric current, such as an alternating electric current, through the electromagnet. The varying electric current in the electromagnet produces a varying magnetic field. The varying magnetic field penetrates a susceptor suitably positioned with respect to the electromagnet, generating eddy currents inside the susceptor. The susceptor has electrical resistance to the eddy currents, and hence the flow of the eddy currents against this resistance causes the susceptor to be heated by Joule heating. In cases whether the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field.

In inductive heating, as compared to heating by conduction for example, heat is generated inside the susceptor, allowing for rapid heating. Further, there need not be any physical contact between the inductive heater and the susceptor, allowing for enhanced freedom in construction and application.

An induction heater may comprise an RLC circuit, comprising a resistance (R) provided by a resistor, an inductance (L) provided by an induction element, for example the electromagnet which may be arranged to inductively heat a susceptor, and a capacitance (C) provided by a capacitor, connected in series. In some cases, resistance is provided by the ohmic resistance of parts of the circuit connecting the inductor and the capacitor, and hence the RLC circuit need not necessarily include a resistor as such. Such a circuit may be referred to, for example, as an LC circuit. Such circuits may exhibit electrical resonance, which occurs at a particular resonant frequency when the imaginary parts of impedances or admittances of circuit elements cancel each other. Resonance occurs in an RLC or LC circuit because the collapsing magnetic field of the inductor generates an electric current in its windings that charges the capacitor, while the discharging capacitor provides an electric current that builds the magnetic field in the inductor. When the circuit is driven at the resonant frequency, the series impedance of the inductor and the capacitor is at a minimum, and circuit current is maximum. Driving the RLC or LC circuit at or near the resonant frequency may therefore provide for effective and/or efficient inductive heating.

A transistor is a semiconductor device for switching electronic signals. A transistor typically comprises at least three terminals for connection to an electronic circuit.

A field effect transistor (FET) is a transistor in which the effect of an applied electric field may be used to vary the effective conductance of the transistor. The field effect transistor may comprise a body B, a source terminal S, a drain terminal D, and a gate terminal G. The field effect transistor comprises an active channel comprising a semiconductor through which charge carriers, electrons or holes, may flow between the source S and the drain D. The conductivity of the channel, i.e. the conductivity between the drain D and the source S terminals, is a function of the potential difference between the gate G and source S terminals, for example generated by a potential applied to the gate terminal G. In enhancement mode FETs, the FET may be off (i.e. substantially prevent current from passing therethrough) when there is substantially zero gate G to source S voltage, and may be turned on (i.e. substantially allow current to pass therethrough) when there is a substantially non-zero gate G-source voltage.

An n-channel (or n-type) field effect transistor (n-FET) is a field effect transistor whose channel comprises a n-type semiconductor, where electrons are the majority carriers and holes are the minority carriers. For example, n-type semiconductors may comprise an intrinsic semiconductor (such as silicon for example) doped with donor impurities (such as phosphorus for example). In n-channel FETs, the drain terminal D is placed at a higher potential than the source terminal S (i.e. there is a positive drain-source voltage, or in other words a negative source-drain voltage). In order to turn an n-channel FET “on” (i.e. to allow current to pass therethrough), a switching potential is applied to the gate terminal G that is higher than the potential at the source terminal S.

A p-channel (or p-type) field effect transistor (p-FET) is a field effect transistor whose channel comprises a p-type semiconductor, where holes are the majority carriers and electrons are the minority carriers. For example, p-type semiconductors may comprise an intrinsic semiconductor (such as silicon for example) doped with acceptor impurities (such as boron for example). In p-channel FETs, the source terminal S is placed at a higher potential than the drain terminal D (i.e. there is a negative drain-source voltage, or in other words a positive source-drain voltage). In order to turn a p-channel FET “on” (i.e. to allow current to pass therethrough), a switching potential is applied to the gate terminal G that is lower than the potential at the source terminal S (and which may for example be higher than the potential at the drain terminal D).

A metal-oxide-semiconductor field effect transistor (MOSFET) is a field effect transistor whose gate terminal G is electrically insulated from the semiconductor channel by an insulating layer. In some examples, the gate terminal G may be metal, and the insulating layer may be an oxide (such as silicon dioxide for example), hence “metal-oxide-semiconductor”. However, in other examples, the gate may be from other materials than metal, such as polysilicon, and/or the insulating layer may be from other materials than oxide, such as other dielectric materials. Such devices are nonetheless typically referred to as metal-oxide-semiconductor field effect transistors (MOSFETs), and it is to be understood that as used herein the term metal-oxide-semiconductor field effect transistors or MOSFETs is to be interpreted as including such devices.

A MOSFET may be an n-channel (or n-type) MOSFET where the semiconductor is n-type. The n-channel MOSFET (n-MOSFET) may be operated in the same way as described above for the n-channel FET. As another example, a MOSFET may be a p-channel (or p-type) MOSFET, where the semiconductor is p-type. The p-channel MOSFET (p-MOSFET) may be operated in the same way as described above for the p-channel FET. An n-MOSFET typically has a lower source-drain resistance than that of a p-MOSFET. Hence in an “on” state (i.e. where current is passing therethrough), n-MOSFETs typically generate less heat as compared to p-MOSFETs, and hence may waste less energy in operation than p-MOSFETs. Further, n-MOSFETs typically have shorter switching times (i.e. a characteristic response time from changing the switching potential provided to the gate terminal G to the MOSFET changing whether or not current passes therethrough) as compared to p-MOSFETs. This can allow for higher switching rates and improved switching control.

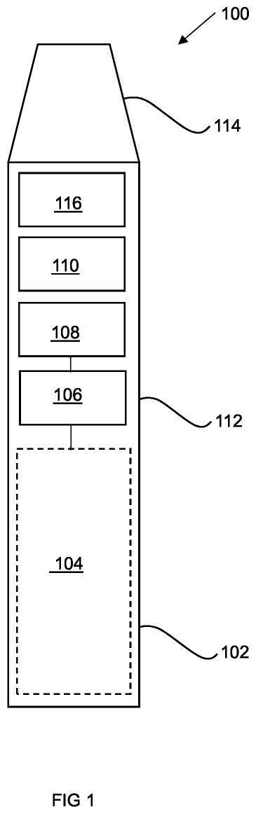

FIG. 1 illustrates schematically a device 100, according to an example. The device 100 is a non-combustible aerosol provision device 100. The non-combustible aerosol provision device 100 comprises a DC power source 104, in this example a battery 104, circuitry 106, an induction element 108, and a susceptor 110, which is arranged to heat an aerosol-generating material 116. The DC power source 104 is electrically connected to the circuitry 106. The DC power source is 104 is arranged to provide DC electrical power to the circuitry 106. The circuitry 106 is electrically connected to the induction element 108. The induction element 108 may be, for example, an electromagnet, for example a coil or solenoid, which may for example be planar, which may for example be formed from copper. The circuitry 106 is arranged to convert an input DC current from the DC power source 104 into a varying, for example alternating, current. The circuitry 106 is arranged to drive the varying current through the induction element 108.

The susceptor 110 is arranged relative to the induction element 108 for inductive energy transfer from the induction element 108 to the susceptor 110. The susceptor may comprise a ferromagnetic portion, which may comprise one or a combination of example metals such as iron, nickel and cobalt. The induction element 108, having varying current driven therethrough, causes the susceptor 110 to heat up by Joule heating and/or by magnetic hysteresis heating, as described above. The susceptor 110 is arranged to heat the aerosol-generating material 116 by, for example, conduction, convection, and/or radiation heating, to generate an aerosol in use. In some examples, the susceptor 110 and the aerosol-generating material 116 form an integral unit that may be inserted and/or removed from the non-combustible aerosol provision device 100, and may be disposable. For example, the aerosol-generating material 116 and susceptor 110 may be comprised in a consumable article. In such examples, the device 100 and the article together may be referred to as a non-combustible aerosol provision system. In other examples, the aerosol-generating material 116 may be replaceable while the susceptor 110 forms a permanent part of the device 100. In some examples, the induction element 108 may be removable from the device 100, for example for replacement. The non-combustible aerosol provision device 100 may be hand-held. The non-combustible aerosol provision device 100 may be arranged to heat the aerosol-generating material 116 to generate aerosol for inhalation by a user.

Returning to FIG. 1, the non-combustible aerosol provision device 100 comprises an outer body 112 housing the battery 104, the circuitry 106, the induction element 108, the susceptor 110, and the aerosol-generating material 116. The outer body 112 comprises a mouthpiece 114 to allow aerosol generated in use to exit the device 100.

In use, a user may activate, for example via a button (not shown) or a puff detector (not shown), which is known per se, the circuitry 106 to cause varying current to be driven through the induction element 108, thereby inductively heating the susceptor 116, which in turn heats the aerosol-generating material 116, and causes the aerosol-generating material 116 thereby to generate an aerosol. The aerosol is generated into air drawn into the device 100 from an air inlet (not shown), and is thereby carried to the mouthpiece 114, where the aerosol exits the device 100.

In at least some examples a vapor is produced that then at least partly condenses to form an aerosol before exiting the non-combustible aerosol provision device for inhalation by a user.

In this respect, first it may be noted that, in general, a vapor is a substance in the gas phase at a temperature lower than its critical temperature, which means that for example the vapor can be condensed to a liquid by increasing its pressure without reducing the temperature. On the other hand, in general, an aerosol is a colloid of fine solid particles or liquid droplets, in air or another gas. A “colloid” is a substance in which microscopically dispersed insoluble particles are suspended throughout another substance.

For reasons of convenience, as used herein the term aerosol should be taken as meaning an aerosol, a vapor or a combination of an aerosol and vapor.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorant. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

The one or more other functional materials may comprise one or more of pH regulators, coloring agents, preservatives, binders, fillers, stabilizers, and/or antioxidants.

The aerosol-former material may comprise one or more constituents capable of forming an aerosol. In some embodiments, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor, as described above.

The circuitry 106, induction element 108, susceptor 110 and/or the device 100 as a whole may be arranged to heat the aerosol-generating material 116 to a range of temperatures to volatilize at least one component of the aerosol-generating material 116 without combusting the aerosol-generating material 116. For example, the temperature range may be about 50° C. to about 350° C., such as between about 50° C. and about 250° C., between about 50° C. and about 150° C., between about 50° C. and about 120° C., between about 50° C. and about 100° C., between about 50° C. and about 80° C., or between about 60° C. and about 70° C. In some examples, the temperature range is between about 160° C. and about 280° C. or between about 170° C. and about 220° C. In some examples, the temperature range may be other than this range, and the upper limit of the temperature range may be around 280° C., or greater than 300° C.

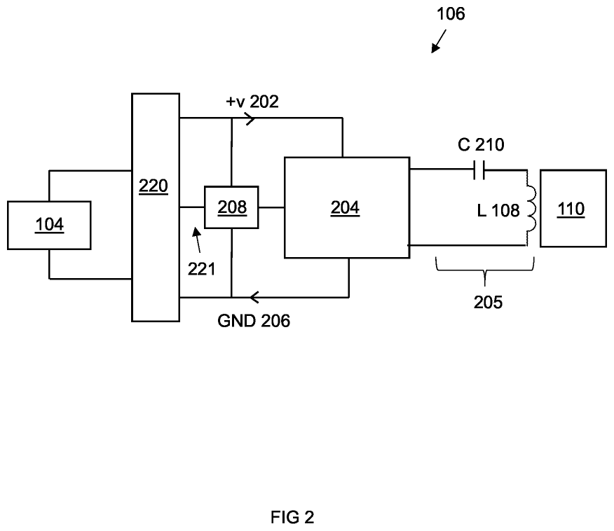

Referring now to FIG. 2, there is illustrated schematically in more detail the circuitry 106 for the induction element 108 for the non-combustible aerosol provision device 100, according to an example.

The circuitry 106 comprises a driver arrangement 204 also referred to herein as drive circuitry 204. The circuitry 106 also comprises a driver control arrangement 208 and a controller 220 which, together, may be described herein as control circuitry. The controller 220 is electrically connected to the battery 104 such that the battery 104 supplies a DC voltage to the controller 220. In examples, the controller 220 is a processing unit, e.g. an MCU, which is configured to receive power from the battery 104 and which comprises a plurality of outputs for outputting electrical signals to the circuitry 106 and, in some examples, to other components of the device 100. The driver arrangement 204 is electrically connected to a positive terminal of the controller 220 that provides a relatively high electric potential +v 202, and to a negative terminal of the controller 220, which, in examples, is connected to ground, and which provides a relatively low electric potential GND 206. In examples, the voltage output by the controller 220 across driver arrangement 204 is substantially equal to the voltage supplied to the controller 220 by the battery 104. A voltage is therefore established across the driver arrangement 204.

The driver arrangement 204 is electrically connected to an LC induction circuit 205 comprising the induction element 108 having inductance L, and a capacitor 210 having capacitance C, which are, in this example, connected in series.

The driver arrangement 204 is arranged to provide, from an input direct current from the battery 104 via the controller 220, a varying voltage across the LC circuit 205. This causes a varying current to flow through the induction element 108 in use.

The driver control arrangement 208 is arranged to control the driver arrangement 204, or components thereof, to control the voltage output by the driver arrangement across the LC circuit 205. Specifically, in this example, as described in more detail below, the driver control arrangement 208 is arranged to control the provision of switching potentials to transistors of the driver arrangement 204 at varying times to cause the driver arrangement 204 to produce the varying current.

The driver control arrangement 208 is electrically connected, via the controller 220, to the battery 104, from which, in this example, the switching potentials are also derived.

In this example, the driver control arrangement 208 is also connected to positive and negative terminals of the controller 220 and thereby an electric potential is supplied to the driver control arrangement 208 to power the driver control arrangement 208 and allow the driver control arrangement 208 to generate the switching potentials for controlling the driver arrangement 204. In this example, the driver control arrangement 208 is connected to different terminals of the controller 220 than the terminals which supply the battery voltage +v to the driver arrangement 204. This will be described in more detail below, with reference to later figures.

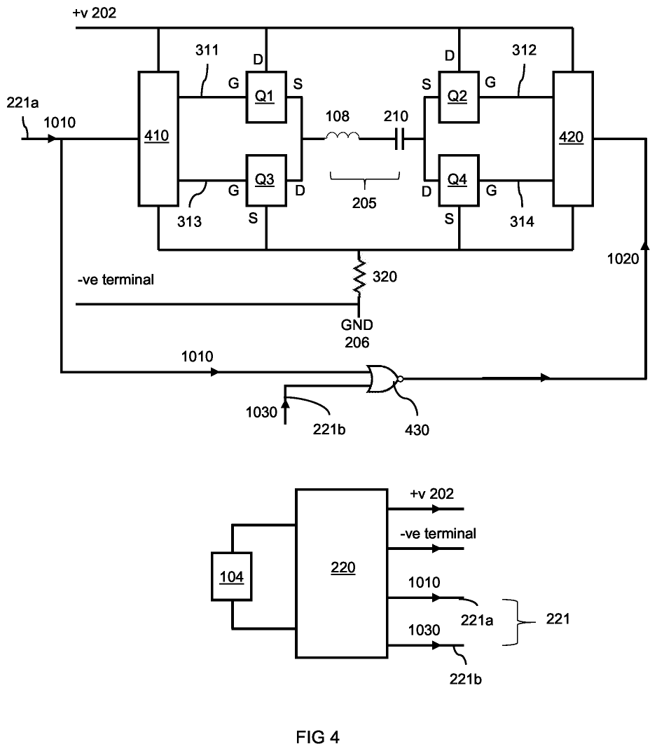

The driver control arrangement 208 comprises further connections 221 to the controller 220 for receiving control signals from the controller 220. The further connections 221 are shown in simplified form as a single line in FIG. 2. Further details of the connections 221 will be described below with reference to FIG. 4.

Powered by the electric potential supplied by the controller 220, derived from the battery 104, the driver control arrangement 208 is arranged to provide the switching potentials to control the driver arrangement 204. The switching potentials are selected to be appropriate for causing switching the transistors of the driver arrangement 204. The switching potentials may be, for example, less than or equal to the battery voltage +v. The value of the switching potentials may depend on the type of transistors used in the driver arrangement 204.

In this example, the driver control arrangement 208 is arranged to control the frequency of varying, e.g. alternating, voltage provided across the LC circuit 205 and hence the frequency of the varying current driven through the induction element 108. As mentioned above, LC circuits may exhibit resonance. In some examples, the driver control arrangement 208 controls the frequency of the varying current driven through the LC circuit (the drive frequency) to be at or near the resonant frequency of the LC circuit 205. For example, the drive frequency may be in the MHz range, for example in the range 0.5 to 1.5 MHz for example 1 MHz. In another example, the drive frequency may be in the kHz range, for example in the range 100 kHz to 1 MHz, for example around 400 kHz. It will be appreciated that other frequencies may be used, for example depending on the particular LC circuit 205 (and/or components thereof), and/or susceptor 110 used. For example, it will be appreciated that the resonant frequency of the LC circuit 205 may be dependent on the inductance L and capacitance C of the circuit 205, which in turn may be dependent on the inductor 108, capacitor 210 and susceptor 110 used.

In use, when the driver control arrangement 208 is activated, for example by a user, the driver control arrangement 208 controls the driver arrangement 204 to drive varying current through the LC circuit 205 and hence through the induction element 108, thereby inductively heating the susceptor 116. The induction element 108 is thereby caused to heat an aerosol-generating material (not shown in FIG. 2), to produce an aerosol for inhalation by a user, for example.

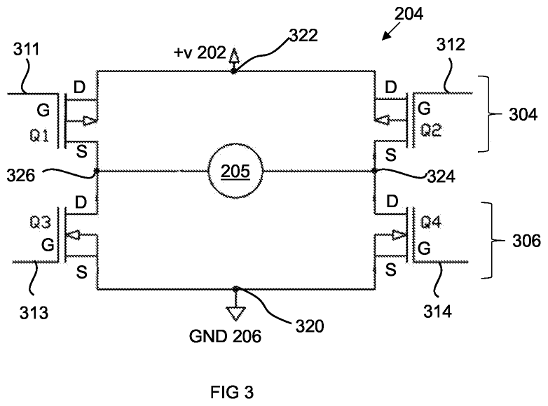

Referring now to FIG. 3, there is illustrated schematically in more detail the driver arrangement 204. The driver arrangement 204 comprises a plurality of transistors, in this example four transistors Q1, Q2, Q3, Q4, arranged in an H-bridge configuration (note that transistors arranged or connected in a H-bridge configuration may be referred to as an H-bridge).

The H-bridge configuration comprises a high side pair 304 of transistors Q1, Q2 and a low side pair 306 of transistors Q3, Q4. A first transistor Q1 of the high side pair 304 is electrically adjacent to a third transistor Q3 of the low side pair 306, and a second transistor Q2 of the high side pair 304 is electrically adjacent to a fourth transistor Q4 of the low side pair 314. The high side pair 304 are for connection to a first electric potential +v 202 higher than a second electric potential GND 206 to which the low side pair 306 are for connection.

In this example, the driver arrangement 204 is arranged for connection of the battery potential +v, supplied from the controller 220 (not shown in FIG. 3), across a first point 322 between the high side pair 304 of transistors Q1, Q2 and a second point 320 between the low side pair 306 of transistors Q3, Q4. Specifically, the first point 322 is for connection to the terminal of the controller 220 which provides outputs the positive battery voltage output +v and the second point 320 is for connection to the terminal of the controller 220 which connects to the negative terminal of the battery 104. Accordingly, in use, a potential difference is established between the first point 322 and the second point 320.

As described with reference to FIG. 2, the driver arrangement 204 is electrically connected to, and arranged to drive, the LC circuit 205 comprising the induction element (not shown in FIG. 3). Specifically, the induction element (as part of the LC circuit 205) is connected across a third point 324 between one of the high side pair of transistors Q2 and one of the low side pair of transistors Q4 and a fourth point 326 between the other of the high side pair of transistors Q1 and the other of low side second pair of transistors Q3.

In this example, each of the transistors Q1, Q2, Q3, Q4 is an n-channel field effect transistor. Each field effect transistor Q1, Q2, Q3, Q4 is controllable by a switching potential to selectively allow current to pass therethrough in use. Each field effect transistor Q1, Q2, Q3, Q4 comprises a source S, a drain D, and a gate G. The switching potential is provided to the gate G of each field effect transistor Q1, Q2, Q3, Q4, which as described above may allow current to pass between the source S and the drain D of each field effect transistor Q1, Q2, Q3, Q4. Accordingly, each field effect transistor Q1, Q2, Q3, Q4 is arranged such that, when the switching potential is provided to the field effect transistor Q1, Q2, Q3, Q4 then the field effect transistor Q1, Q2, Q3, Q4, is “on”, and allows current to pass therethrough, and when the switching potential is not provided to the field effect transistor Q1, Q2, Q3, Q4, then the field effect transistor Q1, Q2, Q3, Q4 is “off”, and has a high resistance such that current is substantially prevented from passing therethrough.

In the example illustrated in FIG. 3, each field effect transistor Q1, Q2, Q3, Q4 has an associated switching voltage line 311, 312, 313, 314 (respectively) for carrying the switching voltage thereto.

The driver control arrangement 208 (not shown in FIG. 3, but see FIG. 2) is arranged to control supply of the switching potentials to each field effect transistor Q1, Q2, Q3, Q4 to control whether each respective transistor Q1, Q2, Q3, Q4 is in an “on” mode (i.e. low resistance mode where current passes therethrough) or an “off” mode (i.e. high resistance mode where substantially no current passes therethrough).

By controlling the timing of the provision of the switching potentials to the respective field effect transistors Q1, Q2, Q3, Q4, the driver control arrangement 208 may cause a varying, e.g. alternating, voltage to be provided across the LC circuit 205, and hence for varying current to be provided to the induction element (not shown in FIG. 3) thereof.

As will be discussed in more detail below, the driver control arrangement 208 can be used to control the sequence of switching “on” and “off” of the field effect transistors Q1, Q2, Q3, Q4 to thereby control the varying voltage which is supplied across the induction circuit.

For example, at a first time, the driver control arrangement 208 may be in a first switching state, where a switching potential is provided to the first and the fourth field effect transistors Q1, Q4, but not provided to the second and the third field effect transistors Q2, Q3. Hence the first and fourth field effect transistors Q1, Q4 will be in a low resistance mode, whereas second and third field effect transistors Q2, Q3 will be in a high resistance mode. Therefore, at this first time, current is allowed to flow from the first point 322 of the driver arrangement 204, through the first field effect transistor Q1, through the LC circuit 205 in a first direction (left to right in the sense of FIG. 3), through the fourth field effect transistor Q4 to the second point 320 of the driver arrangement 204. However, at a second time, the driver controller 208 may be in a second switching state, where a switching potential is provided to the second and third field effect transistors Q2, Q3, but not provided to the first and the fourth field effect transistors Q1, Q4. Hence the second and third field effect transistors Q2, Q3 will be in a low resistance mode, whereas first and fourth field effect transistors Q1, Q4 will be in a high resistance mode. Therefore, at this second time, current is allowed to flow from the first point 322 of the driver arrangement 204, through the second field effect transistor Q2, through the LC circuit 205 in a second direction opposite to the first direction (i.e. right to left in the sense of FIG. 3), through the third field effect transistor Q3 to the second point 320 of the driver arrangement 204. By alternating between the first and second switching state therefore, the driver controller 208 may control the driver arrangement 204 to provide (i.e. drive) an alternating voltage across the LC circuit 205 and hence a varying current through the induction element 108.

During the type of operation described above each of the transistors Q1, Q2, Q3, Q4 of the H-bridge are “on” at some times and “off” at other times. The H-bridge alternates between: in the first switching state, a first of the high side pair of transistors 304 being “on” and a transistor of the low side pair 306 on the opposite side of the H-bridge being “on”; and, in the second switching state, the other of the high side pair 304 of transistors being “on” and the other transistor of the low side pair 306 being “on”. This causes the polarity of the voltage supplied by the driver arrangement 204 across the induction circuit 205 to repeatedly alternate. This type of operation may be referred to herein as the driver arrangement 204 operating in a “full-bridge” mode.

As well as operating in the above-described full-bridge mode, the driver arrangement 204 is also configured to operate in a second mode in which the H-bridge repeatedly alternates between providing a voltage having a non-zero magnitude across the induction circuit 205 and substantially not providing a voltage across the induction circuit 205. In examples, this may be referred to as operating in a “half-bridge” mode. In the half-bridge mode, the driver arrangement 204 is configured to alternate between a third switching state in which the driver arrangement 204 supplies a voltage across the induction circuit 205 and a fourth switching state in which the driver arrangement 204 provides substantially no voltage across the induction circuit 205. For example, in the third switching state the first and fourth transistors Q1, Q4 may be “on” while the second and third transistors Q2, Q3 are “off”. In the third switching state, current may, accordingly, be allowed to flow through the first transistor Q1 and the fourth transistor Q4 and thus be allowed to flow through the induction circuit 205 in a direction shown as left to right in FIG. 3. In the fourth switching state, all of the transistors Q1, Q2, Q3, Q4 may be off, or at least both of the high side pair 304 or both of the low side pair 306 may be off, such that there is no path for the current to flow through the induction circuit 205 to ground 206. Accordingly, the H-bridge in the half-bridge mode alternates between switching states in a voltage is supplied across the induction circuit 205 and in which substantially no voltage is supplied across the induction circuit 205.

Equally, when the H-bridge 204 is operating in the half-bridge mode, current may be allowed to flow through the second transistor Q2 and the third transistor Q3 in the third switching state (right to left in the sense shown in FIG. 3) to provide a voltage across the induction circuit 205, while substantially no voltage is supplied across the induction circuit 205 in the fourth switching state.

In other words, when operating in the half-bridge mode, alternately, the driver arrangement 204 alternates between providing a positive voltage or a negative voltage across the induction circuit 205 in one state and providing substantially no voltage across the induction circuit 205 in another state. This can be contrasted to the full-bridge mode, in which the driver arrangement 204 repeatedly alternates between providing a positive voltage and a negative voltage across the induction circuit 205.

In examples, in the half-bridge mode a voltage is supplied across the induction circuit a lower proportion of the time than in the full-bridge mode. Accordingly, causing the H-bridge to operate in the half-bridge mode may be used to reduce, when compared to the full-bridge mode, power transfer to the susceptor 110 by the induction element 108 and thereby to reduce the degree to which the susceptor 110 is heated by the device 100. In examples, the device 100 may be configured to selectively operate in one of the full-bridge mode and the half-bridge mode depending on the degree which it is desired to heat the susceptor 110. By way of example, a lower heating power may be used to maintain the susceptor 110 at a target temperature when compared to the heating power used to increase the temperature of the susceptor 110 to the target temperature. In such examples, the device 100 may be configured to operate in the full-bridge mode to supply a high power to increase a temperature of the susceptor 110, e.g. to bring the susceptor 110 up to a target operating temperature for heating the aerosol-generating material 116. Then, when the target operating temperature is substantially reached, the device 100 may switch to operating in the half-bridge mode, thereby to supply a lower heating power for maintaining the susceptor 110 at the target temperature.

Other means for controlling the degree by which the susceptor 110 is heated by the induction element 108 may also be used by the device 100. For example, the heating power of the induction element 108 may be controlled by controlling a frequency at which the driver arrangement 204 is driven, i.e. a frequency at which the voltage provided by the driver arrangement 204 across the induction circuit 205 is varied or alternated. In examples, adjustments to the heating power of the induction element 108 may be made by altering the drive frequency when operating in either the full-bridge mode or the half-bridge mode. In examples, switching from operating in the full-bridge mode to operating in the half-bridge mode may result in a large reduction of the heating power, for example the heating power may be reduced by a factor of 4. Accordingly, for example, finer adjustments to the heating power may be made by adjusting the drive frequency while larger adjustments to the heating power may be made by switching modes between the full-bridge and half-bridge modes.

The heating power supplied is dependent on the DC supply voltage and the apparent impedance of the susceptor 110. For example, if the battery 104 supplies 3 volts and the apparent impedance of the susceptor 110 is 0.4 ohms, the heating power available may be determined to be (3 volts*3 volts)/0.4 ohms=22.5 watts. If, however, the battery 104 supplies 4.2 volts, the heating power available may be determined to be (4.2 volts*4.2 volts)/0.4 ohms=44.1 watts. Accordingly, in the example of the battery voltage being 4.2 volts, to supply a heating power of 1.5 watts, which may be for example the power determined to be required to maintain the susceptor 110 at the desired temperature, 1.5 watts of the available power of 44.1 watts should be supplied. This means that in this example it will be necessary to control the power over a ratio of 44.1/1.5 or, equivalently, 29.4 to 1. Switching to half-bridge mode reduces the available power by a factor of 4 such that, in this example, 1.5 watts of an available power of around 11 watts should be supplied to maintain the susceptor temperature. This is a ratio of around 7.35 to 1. Accordingly, switching to the half-bridge mode reduces the range over which the supplied power needs to be controlled to supply the desired heating power.

In some examples, control of the heating power by controlling the drive frequency is performed in the manner described in WO2018/178114A2, the entirety of which is incorporated herein by reference. For example, the controller 220 may be configured to drive the H-bridge 204 at the resonant frequency of the induction circuit 205, which may be measured, or, e.g., pre-determined, to maximize the heating power. To reduce the heating power when compared to driving at the resonant frequency of the induction circuit 108, the controller 220 may drive the H-bridge at a frequency different to, e.g. lower than, the resonant frequency of the induction circuit 205. This may be referred to as driving the circuit “off-resonance” and may reduce the degree to which the susceptor 110 is heated by the induction element 108. When driven off-resonance, less current flows in the resonance circuit when compared to when the circuit is driven at the resonant frequency. Therefore, for a given supply voltage, the energy transfer from the inductor 108 to the susceptor 110 will be less, and hence the degree to which the susceptor 110 is inductively heated will be less, as compared to the degree to which the susceptor 110 is inductively heated when the circuit is driven at the resonant frequency, for the given supply voltage. The further away (above or below) the frequency at which the H-bridge drives the resonant circuit 205 is from the resonant frequency, the less is the degree to which susceptor 110 is inductively heated.

In some examples, additionally or alternatively to controlling the heating power by controlling the drive frequency of the driver arrangement 204, the input voltage to the H-bridge 204 may be controlled. For example, the input voltage may be reduced to reduce the degree by which the susceptor 110 is heated and increased to increase the degree by which the susceptor 110 is heated.

FIG. 4 shows further details of the circuitry 106, in particular showing details of the driver control arrangement (not labelled in FIG. 4 due to the disparate representation of the components making up the driver control arrangement, but see driver control arrangement 208 in FIG. 2).

As shown in FIG. 4, the driver control arrangement 208 comprises a first driver 410 arranged to supply, via the supply lines 311, 313, switching potentials to the first transistor Q1 and the second transistor Q3. The driver control arrangement 208 also comprises a second driver 420 arranged to supply, via the supply lines 312, 314, switching potentials to the second transistor Q2 and the fourth transistor Q4. As described above, the first driver 410 and the second driver 420 are connected between the terminal of the controller 220 which provides the battery voltage +v and the terminal of the controller 220 which connects to the negative terminal of the battery 104. In this example, the first driver 410 and the second driver 420 are connected in parallel with the H-bridge 204. As also shown in FIG. 4, a resistor 320 is electrically connected between the first and second drivers 410, 420, the third and fourth transistors Q3, Q4 and the terminal of the controller 220 which connects to the negative terminal of the battery 104. In examples, the resistor 320 may be used as a current source resistor for monitoring (e.g. by the controller 220) the current flowing through the H-bridge 204 to ground GND 206.

The first driver 410 and the second driver 420 receive respective drive signals 1010, 1020 which control the switching potentials supplied by the first driver 410 and the second driver 420 to the transistors Q1, Q2, Q3, Q4 via respective supply lines 311, 312, 313, 314. The first and second drive signals 1010, 1020 derive from the controller 220 and other circuitry making up the driver control arrangement 208, as will be discussed below in more detail. In this example, the drive signals 1010, 1020 are square-wave signals which alternate between high and low values, which will be labelled “1” and “0” in the following discussion. In an example, to cause the driver arrangement 204 to operate in the full-bridge mode, the drive signals 1010, 1020 are in anti-phase with one another. That is, when the first drive signal 1010 has the value 1 the second drive signal 1020 has the value 0, and vice versa. For example, the first drive signal 1010 may be a square-wave signal at a phase of 0 degrees while the second drive signal 1020 may be a square-wave signal at a phase of 180 degrees.

At any one time, whether the first signal 1010 has a value of 1 or 0 determines the switching potentials provided by the first driver 410 to the first transistor Q1 and the third transistor Q3. Similarly, at any one time, whether the second signal 1020 has a value of 1 or 0 determines the switching potentials provided by the second driver 420 to the second transistor Q2 and the fourth transistor Q4. In one example, when the first drive signal 1010 has a value of 1, the first driver 410 provides switching potentials to the first transistor Q1 and the third transistor Q3 to cause the first transistor Q1 to be “on” and the third transistor Q3 to be “off”, where, as described above, when a given transistor is “on” it allows current to flow therethrough while when a given transistor is “off” it does not allow current to flow therethrough. This corresponds with the first switching state, described above. Further, in this example, when the first drive signal 1010 has a value of 0 the first driver 410 provides switching potentials to the first transistor Q1 and the third transistor Q3 to cause the first transistor Q1 to be “off” and the third transistor Q3 to be “on”. This corresponds to the second switching state described above.

Similarly, in the same example, when the second drive signal 1020 has a value of 1 the second driver 420 provides switching potentials to the second transistor Q2 and the fourth transistor Q4 to cause the second transistor Q2 to be “on” and the fourth transistor Q4 to be “off”; and when the second drive signal 1020 has a value of 0 the second driver 420 provides switching potentials to the second transistor Q2 and the fourth transistor Q4 to cause the second transistor Q2 to be “off” and the fourth transistor Q4 to be “on”. This is summarized below, in Table 1.

TABLE 1

| | | | | | | Direction of |
|---|---|---|---|---|---|---|
| | | | | | | voltage drop |
| First drive | | | Second drive | | | across induction |
| signal | Q1 | Q3 | signal | Q2 | Q4 | circuit 205, in |
| 1010 | state | state | 1020 | state | state | FIG. 4 |
| 1 | ON | OFF | 0 | OFF | ON | Left to right |
| 0 | OFF | ON | 1 | ON | OFF | Right to left |

The above described arrangement is such that providing first and second drive signals 1010, 1020 in anti-phase with one another causes the driver arrangement 204 to operate in the full-bridge mode with the voltage across the induction circuit 205 repeatedly alternating polarity, or, in other words, the direction of the voltage drop across the induction circuit 205 repeatedly changing direction, as the values of the first and second drive signals 1010, 1020 alternate. Since the drive signals 1010, 1020 are square-wave signals, when operating in this mode, at substantially any one time, a voltage drop is being provided across the induction circuit 205 in one direction or the other.

This may be thought of as the first transistor Q1 and the fourth transistor Q4 supplying a first square wave voltage signal to the induction circuit 205 and the second transistor Q2 and the third transistor Q3 supplying a second square wave voltage signal to the induction circuit 205 wherein the first and second square wave signals are 180 degrees out of phase with one another. In this example, each of the first and second square wave signals alternates between the DC supply voltage, e.g. 4V, and 0V. Accordingly, the effect of the full-bridge operation may be thought of as providing a combined square wave signal at twice the DC supply voltage.

Now returning to FIG. 4, the driver control arrangement 208 comprising the first and second drivers 410, 420 can be seen to comprise a logic gate 430. The logic gate 430 takes the first drive signal 1010 as a first input and a control signal 1030 as a second input and provides the second drive signal 1020 as an output. The first drive signal 1010 and the control signal 1030 input to the logic gate 430 are both output from the controller 220. FIG. 4 shows the connections 221 between the controller 220 and the driver control arrangement 208 which were discussed briefly above with reference to FIG. 2 in more detail. A first connection 221a of the connections 221 carries the first drive signal 1010 to the first driver 410 and to the first input of logic gate 430. A second connection of the connections 221 carries the control signal 1030 to the second input of the logic gate 430.

The logic gate 430 is a NOR gate which outputs a value of 1 for the second drive signal 1020 if both of the inputs, the first drive signal 1010 and the control signal 1030, have a value of 0. Otherwise, i.e. if either of the inputs has a value of 1, the NOR gate 430 outputs a value of 0 for the second drive signal 1020.

The second drive signal 1020 output by the NOR gate 430 for different values of the first drive signal 1010 and the control signal 1030 output by the controller 220 is shown below in Table 2.

TABLE 2

| | | | | | Voltage drop |
|---|---|---|---|---|---|
| First | | NOR gate out- | | | direction |
| drive | Control | put (=second | Transis- | Transis- | across induc- |
| signal | signal | drive signal | tors which | tors which | tion circuit |
| 1010 | 1030 | 1020) | are ON | are OFF | 205, in FIG. 4 |
| 1 | 0 | 0 | Q1, Q4 | Q2, Q3 | Left to right |
| 0 | 0 | 1 | Q2, Q3 | Q1, Q4 | Right to left |
| 1 | 1 | 0 | Q1, Q4 | Q2, Q3 | Left to right |
| 0 | 1 | 0 | Q3, Q4 | Q1, Q2 | None |

The first two rows of Table 2 represent the states between which the H-bridge alternates in the full-bridge mode, i.e. the first switching state and the second switching state discussed above. The third and fourth rows of Table 2 represent the states between which the H-bridge alternates in the half-bridge mode.

As can be seen in the first two rows of Table 2, when the control signal 1030 has a value of 0, the second drive signal 1020 has a value of 0 when the first drive signal 1010 has a value of 1 and the second drive signal 1020 has a value of 1 when the first drive signal 1010 has a value of 0. Thus, when the control signal 1030 has a value of 0 the polarity of the voltage provided across the induction circuit 205 by the driver arrangement 204 alternates at the frequency of the first drive signal 1010, in the manner described earlier with reference to Table 1.

However, as can be seen in the third and fourth rows of Table 2, when the control signal 1030 has a value of 1, the second drive signal 1020 has a value of 0, irrespective of the value of the first drive signal 1010. This has the effect of causing the driver arrangement 204 to operate in the half-bridge mode. That is, with the control signal 1030 maintaining a value of 1, the fourth transistor Q4 remains on while the second transistor Q2 remains off. Accordingly, when the first drive signal 1010 has a value of 1 the first transistor Q1 is on (and the second transistor Q2 is also off), and a voltage drop is provided across the induction circuit 205 from left to right as shown in FIG. 4. In other words, in this state, the left side of the circuit 205 is at a higher potential difference than the right side of the induction circuit 205. However, when the first drive signal 1010 has a value of 0, the first transistor Q1 is off while the second transistor Q2 also remains off. Therefore, in this state, although the third and fourth transistors Q3, Q4 may be on, since both of the high side pair of transistors Q1, Q2 are off, substantially no voltage is provided across the induction circuit 205. The driver arrangement 204 therefore operates to only drive current through the induction circuit 205 when the square wave first drive signal 1010 supplied to the first driver 410 has a value of 1. That is, in this example, when operating in the half bridge mode, for substantially half of the time a voltage is supplied across the induction circuit 205 and for substantially the other half of the time no voltage is supplied across the induction circuit 205.

Again, this may be thought of as the first transistor Q1 and the fourth transistor Q4 supplying a first square wave voltage signal to the induction circuit 205 while the remainder of the time no voltage is supplied across the induction circuit 205. Accordingly, the effect of the half-bridge operation compared to the full-bridge operation may be thought of as supplying a square wave signal operating at the DC supply voltage, i.e. having the magnitude of the DC supply voltage half of the time while supplying substantially no voltage the remainder of the time. This may be thought of as a square wave signal operating at a voltage of half the magnitude of the voltage in the square wave provided in the full bridge mode. Thus, the power supplied in the half bridge mode is reduced by a factor of 4 when compared to operation in the full bridge mode.

It can be seen from the above description that the control signal 1030 may therefore be used to select whether the driver arrangement 204 operates in the full-bridge mode or in the half-bridge mode. The arrangement including the NOR gate 430 provides a simple arrangement which, based on the control signal 1030, either provides for the second drive signal 1020 to be in anti-phase with the first drive signal 1010, or which holds the second drive signal 1020 low while the first drive signal 1010 proceeds as a square wave. Accordingly, in this example, only one square wave drive signal, the first drive signal 1010, and the control signal 1030 need be supplied to the driver control arrangement 208. The second drive signal 1020 is output from the NOR gate 430 in response to the input of these two signals and does not need to be separately generated by the controller 220. A simple arrangement for providing the second drive signal 1020 and allowing the driver arrangement 204 to switch between full-bridge and half-bridge operation is thereby provided.

By controlling the first drive signal 1010 and the control signal 1030 the controller 220 can control the operation of the driver arrangement 204 to thereby control heating of the susceptor 110 by the induction element 108. As described above, the controller 220 can use the control signal 1030 to control whether the driver arrangement 204 operates as a half bridge or as a full bridge. This can be used to control the heating power supplied to the susceptor 110. For example, operating in the half bridge mode can cause the heating power supplied by the induction circuit 205 to be reduced by a factor of 4 when compared with operation in the full bridge mode, as described above. In addition, as described above, the controller 220 may, for example, control the frequency of the first drive signal 1010 to control the frequency at which the induction circuit 205 is driven and thereby control the degree to which the susceptor 110 is heated. The arrangement provides that if the controller 220 is to alter the frequency at which the induction circuit 205 is driven, this can be done by altering the frequency of the first drive signal 1010 only.

In the above examples, the driver arrangement 204 comprises four transistors Q1, Q2, Q3, Q4 arranged in a H-bridge configuration but it will be appreciated that in other examples the driver arrangement 204 may comprise further transistors, that may or may not be part of the H-bridge configuration.

In examples described above, each of the transistors Q1, Q2, Q3, Q4 are n-channel transistors, e.g. enhancement mode n-channel metal-oxide-semiconductor field effect transistors. However, in other examples, one or more of the transistors Q1, Q2, Q3, Q4 may be a p-channel field effect transistor, for example an enhancement mode p-channel metal-oxide-semiconductor field effect transistor.

As also described above, for n-channel FETs, the drain terminal D is placed at a higher potential than the source terminal S (i.e. there is a positive drain-source voltage, or in other words a negative source-drain voltage), and in order to turn the n-channel FET “on” (i.e. to allow current to pass therethrough), the switching potential applied to the gate terminal G is higher than the potential at the source terminal S.

Although in the above examples, the field effect transistors Q1, Q2, Q3, Q4 are metal-oxide field effect transistors, it will be appreciated that this need not necessarily be the case and that in other examples other types of transistors, for example high electron mobility transistors (HEMTs) may be used. In some examples, transistors employing wide bandgap materials such as SiC (silicon carbide) and GaN (Gallium Nitride) may be used which may be, for example, FETs or HEMTs.

Though in examples described above the driver control arrangement 208 is powered by the same battery voltage +v supplied via the controller 220, in other examples, the potential across the driver control arrangement 208 may be different to the battery voltage +v. For example, the potentials across the driver control arrangement 208 and across the driver arrangement 204 may be supplied via different outputs from the controller 220.

While in the examples describes above, the driver control arrangement 208 is connected to different terminals of the controller 220 that the terminals which supply the battery voltage +v to the driver arrangement 204, in other examples, the driver arrangement 208 may be supplied with an electric potential by the same terminals which supply the electric potential across the driver arrangement 204.

In examples described above, the non-combustible aerosol provision device 100 comprises a mouthpiece from which the user may inhale the aerosol generated by the device. However, in other examples, the device 100 may not comprise a mouthpiece. For example, an article containing the aerosol-generating material 116 may comprise a portion to be engaged by the mouth of a user from which the user may inhaled the generated aerosol.

In some examples, the non-combustible aerosol provision system is an electronic cigarette, also known as a vaping device or electronic nicotine delivery system (END), although it is noted that the presence of nicotine in the aerosol-generating material is not a requirement.

In some examples, the non-combustible aerosol provision system is an aerosol-generating material heating system, also known as a heat-not-burn system. An example of such a system is a tobacco heating system.

In some examples, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some examples, the hybrid system comprises a liquid or gel aerosol-generating material and a solid aerosol-generating material. The solid aerosol-generating material may comprise, for example, tobacco or a non-tobacco product.

The non-combustible aerosol provision system may comprise the non-combustible aerosol provision device and a consumable for use with the non-combustible aerosol provision device.

In some examples, the disclosure relates to consumables comprising aerosol-generating material and configured to be used with non-combustible aerosol provision devices. These consumables are sometimes referred to as articles or aerosol generating articles throughout the disclosure.

In some examples, the non-combustible aerosol provision system may comprise an area for receiving the consumable, an aerosol generator, an aerosol generation area, a housing, a mouthpiece, a filter and/or an aerosol-modifying agent.

In some examples, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some examples, the substance to be delivered may be an aerosol-generating material or a material that is not intended to be aerosolized. As appropriate, either material may comprise one or more active constituents, one or more flavors, one or more aerosol-former materials, and/or one or more other functional materials.

The material may be present on or in a support, to form a substrate. The support may, for example, be or comprise paper, card, paperboard, cardboard, reconstituted material, a plastics material, a ceramic material, a composite material, glass, a metal, or a metal alloy. In some examples, the support comprises a susceptor. In some examples, the susceptor is embedded within the material. In some alternative examples, the susceptor is on one or either side of the material.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as an inductive element herein but may also be referred to as a magnetic field generator.

An aerosol generator is an apparatus configured to cause aerosol to be generated from the aerosol-generating material. In examples of the present disclosure, the aerosol generator is configured to subject the aerosol-generating material to heat energy, so as to release one or more volatiles from the aerosol-generating material to form an aerosol.

The above examples are to be understood as illustrative examples of the disclosure. It is to be understood that any feature described in relation to any one example may be used alone, or in combination with other features described, and may also be used in combination with one or more features of any other of the examples, or any combination of any other of the other examples. Furthermore, equivalents and modifications not described above may also be employed without departing from the scope of the disclosure, which is defined in the accompanying claims.

1. An apparatus for a non-combustible aerosol provision device, the apparatus comprising:
an induction circuit comprising an induction element for inductively heating a susceptor arrangement arranged to heat an aerosol-generating material to thereby generate an aerosol;
drive circuitry arranged to provide, from an input direct current, a varying voltage across the induction circuit for driving the induction element to inductively heat the susceptor arrangement; and
control circuitry configured to cause the drive circuitry to selectively operate:
in a first mode in which the drive circuitry repeatedly alternates a polarity of the voltage provided across the induction circuit; and
in a second mode in which the drive circuitry repeatedly alternates between providing a first voltage of non-zero magnitude across the induction circuit and providing substantially no voltage across the induction circuit.

2. The apparatus according to claim 1, wherein the drive circuitry comprises a plurality of switching elements arranged in an H-bridge configuration, wherein the plurality of switching elements comprises a high side pair of switching elements comprising a first switching element and a second switching element and a low side pair of switching elements comprising a third switching element and a fourth switching element, and wherein the first switching element and the third switching element are electrically connected to the first side of the induction circuit and the second switching element and the fourth switching element are electrically connected to the second side of the induction circuit.

3. The apparatus according to claim 2, wherein the drive circuitry is arranged for connection of an electric potential in use across a first point between the high side pair of switching elements and a second point between the low side pair of switching elements.

4. The apparatus according to claim 3, wherein:
in the first mode, the control circuitry causes the drive circuitry to alternate between:
allowing current to flow through the first switching element and the fourth switching element to cause the voltage across the induction circuit to have a positive polarity, and
allowing current to flow through the second switching element and the third switching element to cause the voltage across the induction circuit to have a negative polarity; and
in the second mode, the control circuitry causes the drive circuitry to alternate between:
allowing current to flow through the first switching element and the fourth switching element to cause the voltage across the induction circuit to have a positive polarity, or allowing current to flow through the second switching element and the third switching element to cause the voltage across the induction circuit to have a negative polarity, and
providing substantially no voltage across the induction circuit.

5. The apparatus according to claim 3, wherein the control circuitry is configured to cause the drive circuitry to operate in the first mode or the second mode by providing one or more drive signals configured to control which of the plurality of switching elements, at any one time, allows current to flow therethrough.

6. The apparatus according to claim 5, wherein the control circuitry is configured to supply a first drive signal to control switching of the first switching element and the third switching element, and the control circuitry is configured to supply a second drive signal to control switching of the second switching element and the fourth switching element.

7. The apparatus according to claim 6, wherein:
in the first mode, a value of the first drive signal alternates at a first drive frequency and the second drive signal is inverted with respect to the first drive signal to cause the polarity of the voltage across the induction circuit to alternate at the first drive frequency; and
in the second mode, the value of the first drive signal alternates at a second drive frequency and the second drive signal is configured to cause the second switching element to be maintained in a state in which current is substantially prevented from flowing through the second switching element and the fourth switching element to be maintained in a state in which current is allowed to flow through the fourth switching element.

8. The apparatus according to claim 6, wherein the control circuitry is configured to determine the second drive signal based at least in part on the first drive signal.

9. The apparatus according to claim 8 wherein the control circuitry is configured to determine the second drive signal based on, in addition to the first drive signal, a control signal.

10. The apparatus according to claim 9, wherein the control circuitry comprises a controller configured to output the first drive signal and the control signal.

11. The apparatus according to claim 10, wherein the control signal is configured to determine in which of the first mode or the second mode the driver arrangement is caused to operate.

12. The apparatus according to claim 11, wherein the control circuitry comprises a signal processing element configured to receive as inputs the first drive signal and the control signal and to output the second drive signal.

13. The apparatus according to claim 12, wherein the signal processing element is a NOR gate.

14. The apparatus according to claim 2, wherein the control circuitry is configured to control a degree to which the induction element heats the susceptor arrangement by controlling a switching frequency of the plurality of switching elements to control a frequency of the varying current supplied to the induction element.

15. The apparatus according to claim 2, wherein the plurality of switching elements are transistors and the control circuitry is configured to control respective switching potentials supplied to each of the transistors to control switching of the transistors.

16. The apparatus according to claim 15, wherein each of the transistors is an n-channel field effect transistor.

17. The apparatus according to claim 15, wherein each of the transistors comprises a source, a drain, and a gate, and wherein in use the respective switching potentials are provided to the gate of each transistor.

18. The apparatus according to claim 1, wherein the induction circuit is an LC resonant circuit comprising the induction element.

19. The apparatus according to claim 18, wherein the LC resonant circuit comprises the induction element arranged in series with a capacitive element.

20. The apparatus according to claim 1, wherein the control circuitry is configured to control a degree to which the induction element heats the susceptor arrangement by controlling in which of the first mode or the second mode the drive circuitry is operating.

21. A non-combustible aerosol provision device comprising:
the apparatus according to claim 1.

22. The non-combustible aerosol provision device according to claim 21, further comprising:
a DC power source arranged to provide at least one of the input direct current in use or the or a switching potential in use.

23. The non-combustible aerosol provision device according to claim 21, further comprising:
the susceptor arrangement arranged to be inductively heated by the induction element in use.

24. A non-combustible aerosol provision system comprising:
the non-combustible aerosol provision device according to claim 21; and
the aerosol-generating material;
wherein, in use, the aerosol-generating material is arranged to be heated by the susceptor arrangement to generate the aerosol.

25. The non-combustible aerosol provision device according to claim 24, wherein the aerosol-generating material is or comprises tobacco.

26. A method of controlling an apparatus for a non-combustible aerosol provision device, the apparatus comprising an induction circuit comprising an induction element for inductively heating a susceptor arrangement arranged to heat an aerosol-generating material to thereby generate an aerosol; drive circuitry arranged to provide, from an input direct current, a varying voltage across the induction circuit for driving the induction element to inductively heat the susceptor arrangement; and control circuitry; wherein the method comprises:
causing, by the control circuitry, the drive circuitry to selectively operate in a first mode in which the drive circuitry repeatedly alternates a polarity of the voltage provided across the induction circuit, and a second mode in which the drive circuitry repeatedly alternates between providing a first voltage of non-zero magnitude across the induction circuit and providing substantially no voltage across the induction circuit.
